(19) United States
(12) Patent Application Publication
(10) Pub. No.: US 2025/0061187 A1
(43) Pub. Date: Feb. 20, 2025

(54) CONTINUAL BACKUP VERIFICATION FOR RANSOMWARE DETECTION AND RECOVERY

(71) Applicant: VMware, Inc., Palo Alto, CA (US)

(72) Inventors: Boris WEISSMAN, Palo Alto, CA (US); Kiran KAMATH, San Jose, CA (US); Juan Pablo CASARES-CHARLES, Mountain View, CA (US); Piyush KOTHARI, Palo Alto, CA (US); Michael KOLECHKIN, Palo Alto, CA (US); Deepa SREEKUMAR, Sunnyvale, CA (US); Mamta BHAVSAR, Palo Alto, CA (US)

(21) Appl. No.: 18/452,319

(22) Filed: Aug. 18, 2023

(51) Int. Cl. G06F 21/53; G06F 9/455; G06F 21/55; G06F 21/56

(52) U.S. Cl. CPC G06F 21/53; G06F 9/45558; G06F 21/554; G06F 21/566; G06F 2009/4557; G06F 2221/034

(57) ABSTRACT

Aspects of the disclosure provide continual backup verification for ransomware detection and recovery of fileless malicious logic. On an ongoing basis, even prior to detecting an attack within a production environment, each of a plurality of backup virtual machines (VMs) is executed in an isolation environment and subject to behavior monitoring to detect malicious logic (e.g., ransomware). If malicious logic is detected in a backup VM, an alert is generated and/or that backup VM is marked as unavailable for use as a restoration backup, in order to avoid re-infecting the production environment. In some examples, a backup VM with malicious logic is cleaned and returned to the pool of available backups that are suitable for use. Because the production environment is not burdened, in some examples, the probability of detection for finding malicious logic in the isolation environment is set higher than what is used in the production environment.

### BACKGROUND

Some malicious logic used in cyberattacks, such as ransomware, may have significant dwell time prior to manifesting, on the order of days, weeks, or even months. This means that the malicious logic may reside in backups, and recovering from an infected backup may result in reinfection of production workloads because of the lateral spread of infection.

As a further complicating issue, some newer cyberattacks are fileless, such as by using living off the land (LOTL) attacks, which are not detectable with signature-based protection measures. An LOTL attack is a fileless malware cyberattack technique that uses native, legitimate tools (e.g., a PowerShell) within the target computing environment to sustain and advance the attack.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the disclosure provide continual backup verification for ransomware detection and recovery. Examples include: an execution controller for executing each backup virtual machine (VM) of a plurality of backup VMs in an isolation environment, prior to detecting a cyberattack within a production environment; a behavior monitor for monitoring behavior of each executing backup VM to detect malicious logic; and response logic to, based on at least detecting malicious logic from the behavior monitoring of a first backup VM of the plurality of backup VMs: mark the first backup VM as unavailable for backup restore use; and/or generate an alert for the first backup VM.

### BRIEF DESCRIPTION OF THE DRAWINGS

The present description will be better understood from the following detailed description read in the light of the accompanying drawings, wherein:

FIG. 1 illustrates an example architecture that advantageously provides continual backup verification for ransomware detection and recovery;

FIG. 2 illustrates further detail for an example of an architecture that may be used;

FIG. 3 illustrates further detail for a production environment of an example architecture, such as that of FIG. 1;

FIG. 4 illustrates further detail for an isolation environment of an example architecture, such as that of FIG. 1;

FIG. 5 illustrates further detail for an endpoint detection and response (EDR) node of an example architecture, such as that of FIG. 1;

FIG. 6 illustrates further detail for an orchestrator of an example architecture, such as that of FIG. 1;

FIG. 7 illustrates exemplary messaging in an example architecture, such as that of FIG. 1;

FIGS. 8A-8F illustrate exemplary user interfaces (UIs) that may be used in an example architecture, such as that of FIG. 1;

FIGS. 9 and 10 illustrate examples of various flowcharts of exemplary operations associated with an example architecture, such as that of FIG. 1; and

FIG. 11 illustrates a block diagram of an example computing apparatus that may be used as a component of an example architecture such as that of FIG. 1.

Any of the figures may be combined into a single example or embodiment.

### DETAILED DESCRIPTION

Ransomware often resides within a target environment for a significant amount of time (e.g., has a “dwell time” of days, weeks, or months). Detecting the presence of ransomware (or other malicious logic) is facilitated by executing potentially-infected software in a sandbox type environment (e.g., an isolation environment). In a virtualization environment, virtual machines (VMs) are backed up to use for disaster recovery (DR) events. Executing backup VMs within an isolation environment enables detection of even fileless malicious logic prior to the malicious logic manifesting in a production environment. This may not only prevent ransomware (or other cyberattacks) from successfully manifesting within the production environment—precluding potentially significant damage—but may also prevent reinfection in the event that a backup is needed for some other DR event.

Aspects of the disclosure provide continual backup verification for ransomware detection and recovery. On an ongoing basis, even prior to detecting an attack (i.e., without detecting an attack) within a production environment, each of a plurality of backup VMs is executed in an isolation environment and subject to behavior monitoring to detect malicious logic (e.g., ransomware). If malicious logic is detected in a backup VM, an alert is generated and/or that backup VM is marked as unavailable for use as a restoration backup (e.g., a disaster recovery (DR) backup), in order to avoid re-infecting the production environment. In some examples, a backup VM with malicious logic is cleaned and returned to the pool of available backups that are suitable for use in DR. Because the production environment is not burdened, in some examples, the probability of detection (Pd) for finding malicious logic in the isolation environment is set higher than the Pd that is used in the production environment.

Aspects of the disclosure improve security for computing operations by detecting fileless malicious logic prior to the malicious logic manifesting in a production environment. This advantageous operation is achieved, at least in part, by executing each backup VM of a plurality of backup VMs in an isolation environment and monitoring behavior to detect malicious logic. Thus, because detection and mitigation (or prevention) of cyberattacks is a key technical problem in computing, aspects of the disclosure provide a practical, useful result to solve a technical problem in the domain of computing.

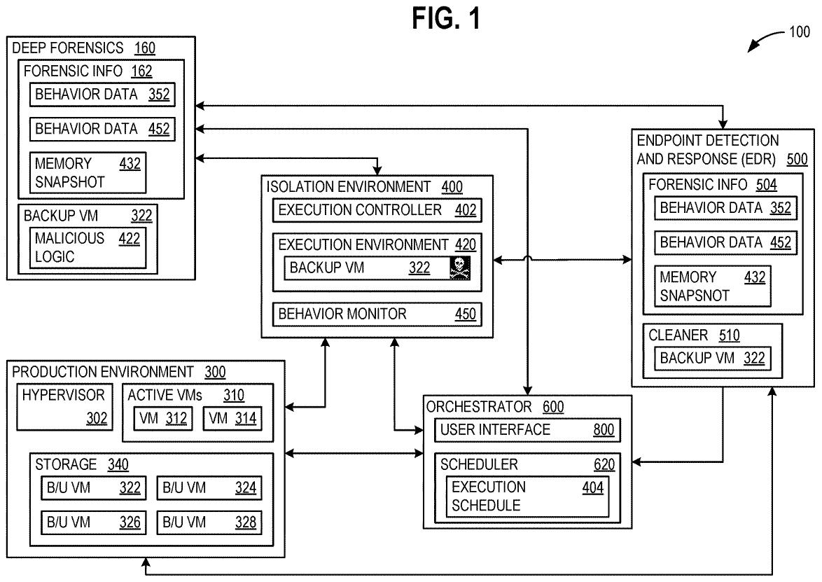

FIG. 1 illustrates an example architecture 100 that advantageously provides continual backup verification for ransomware detection and recovery, along with protection from other forms of malicious logic. In architecture 100, a production environment 300 hosts a set 310 of active VMs, such as a VM 312 and a VM 314, which are executing under the control of a hypervisor 302. Backup VMs 322-328 provide backups for DR events, although without being tested, any of backup VMs 322-328 may contain malicious logic and risk reinfecting production environment 300 if used for DR (e.g., to recover from a cyberattack, a crash or environmental disaster).

To detect any malicious logic within backup VMs 322-328, backup VMs 322-328 are sent to an isolation environment 400, which may be an isolated recovery environment (IRE). In some examples, to make optimal use of computing resources, production environment 300 has the majority of computing power and storage, such as ten times or more hosts than isolation environment 400. Backup VM 322 is shown as being executed within a quarantined execution environment 420 (such as a sandbox), under the control of an execution controller 402. A behavior monitor 450 provides next generation anti-virus (NGAV) functionality by monitoring the behavior of backup VM 322 to identify signs indicating the presence of malicious logic, for example using ML. Even if malicious logic manifests, because the execution is within execution environment 420, production environment 300 is spared from infection. Each of backup VMs 322-328 takes its turn executing, which may be for a period of 8 hours or so, in some examples. In some examples, isolation environment 400 has multiple ones of execution environment 420.

An endpoint detection and response (EDR) node 500 provides assessment services for the behavior information captured from the executing VMs (e.g., backup VM 322), for example using forensic information 504, such as behavior data 452 captured in isolation environment 400, behavior data 352 captured in production environment 300 (if available), and a memory snapshot 432 captured while backup VM 322 is executing. Security scans may be triggered by production environment 300 or isolation environment 400 issuing application programming interface (API) calls to EDR node 500. A memory snapshot can capture fileless malware that is not otherwise persisted to storage. In some examples, a cleaner 510 cleans backup VM 322 so that it may be returned to production environment 300 and used as a DR backup without infecting production environment 300. Cleaner 510, for example, is a tool that automatically removes malicious logic. In other examples, cleaner 510 is a security tool that is manually employed to remove the malicious logic.

This activity is coordinated by an orchestrator 600 that has, among other functionality, a scheduler 620 to schedule the runtimes for backup VMs 322-328. Scheduler 620 periodically examines active recovery plans, and initiates plan verification. Verification plans may be selected based on the minimum desired execution frequency stated in the plan. VMs covered by a plan are grouped into batches sized to match the resources available to isolation environment 400. Resources may be calculated by inspecting target resource pool settings and available physical resources, such as the number of hosts. This information is then used to dynamically batch VMs for verification, enabling determination of the maximum VM batch size without violating recommended overcommit levels for VMs deployed in isolation environment 400. In some examples, users are alerted if isolation environment 400 does not have enough resources to meet the desired execution frequency of backup VMs 322-328, so that more resources may be allocated. In some scenarios, verification plan mappings are used to designate target compute resources for isolation environment 400.

In an example, assuming a recommended CPU overcommit of C=2 and memory overcommit of M=2, VM batch sizes are calculated using aggregate VM CPU and RAM resources available to the IRE and batching plan VMs to stay within the target overcommit limits. A single vCPU is assumed to have a standard execution frequency of 1 GHz. If IRE is allocated 10 GHz of CPU, a batch can contain VMs whose aggregate vCPUs stay within C*10 GHz=20 GHz limit. If a plan has 20 VMs with 2 vCPUs each, this results in a batch size of 20 GHz/(2*1 GHz)=10. This entire example plan requires 2 VM batches of 10 VMs each.

An execution schedule 404 is shown that is used by execution controller 402 to schedule each of backup VMs 322-328. Some examples validate execution schedule 404 to warn the user when a plan is not feasible for meeting the desired verification frequency with a resource pool that is too small or requires a longer execution time. Such a validation may be performed by simulating VM batching with available resources and estimating the entire execution time given the known number of batches and a fixed execution duration per batch.

A user interface (UI) 800 permits a user to set various parameters to control the functionality of architecture 100. In some examples, backup VM 322 is validated to be clean from malicious logic (or cleaned) within a day or two of backup VM 322 being created from an active VM (e.g., VM 312).

A deep forensics node 160 is used to examine any VM that manifests behavior that merits further investigation, such as by cybersecurity experts. Deep forensics node 160 has forensic information 162 that may have some or all of the same information as forensic information 504, or even additional information. Backup VM 322 is shown with detected malicious logic 422 that is being examined within deep forensics node 160.

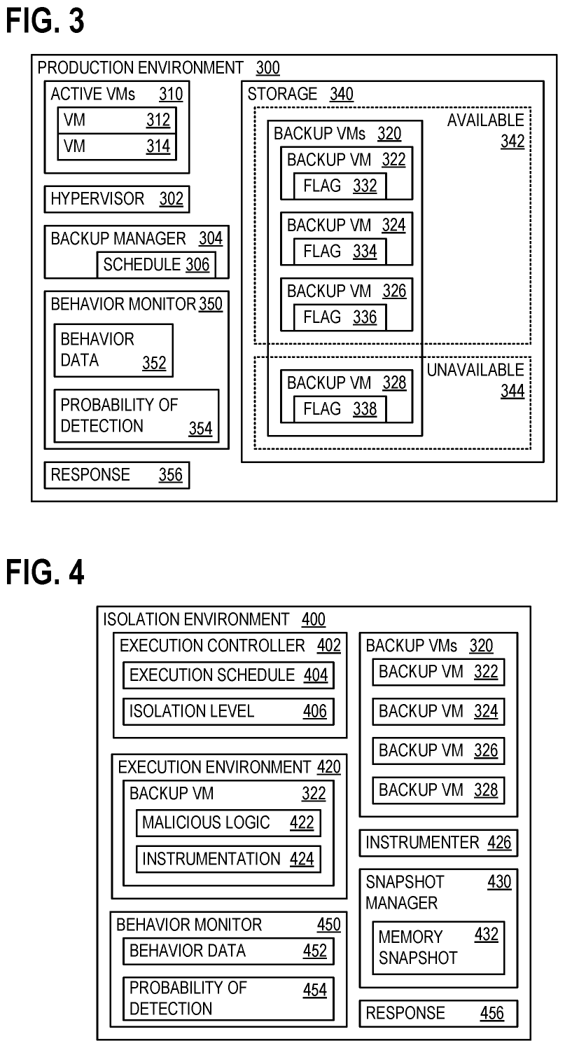

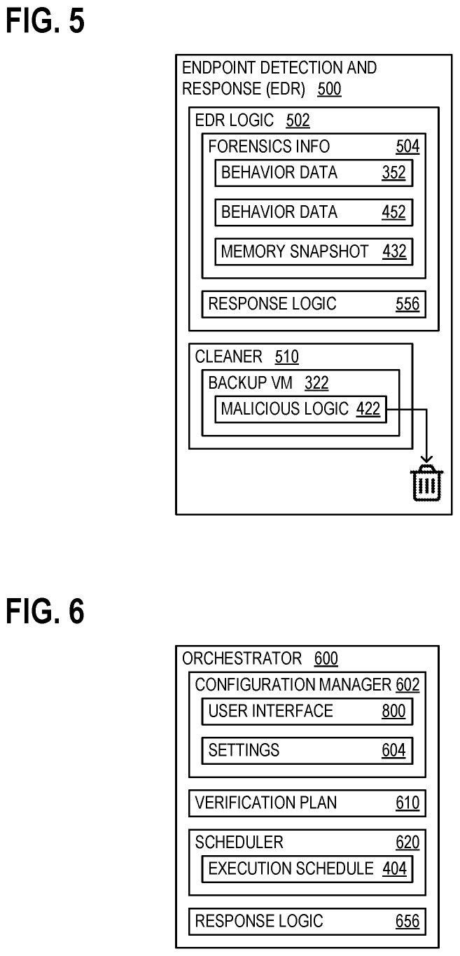

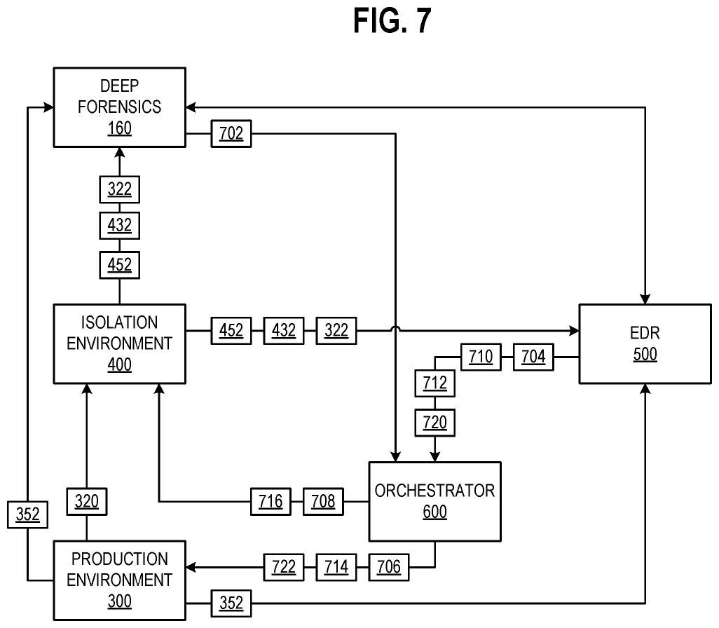

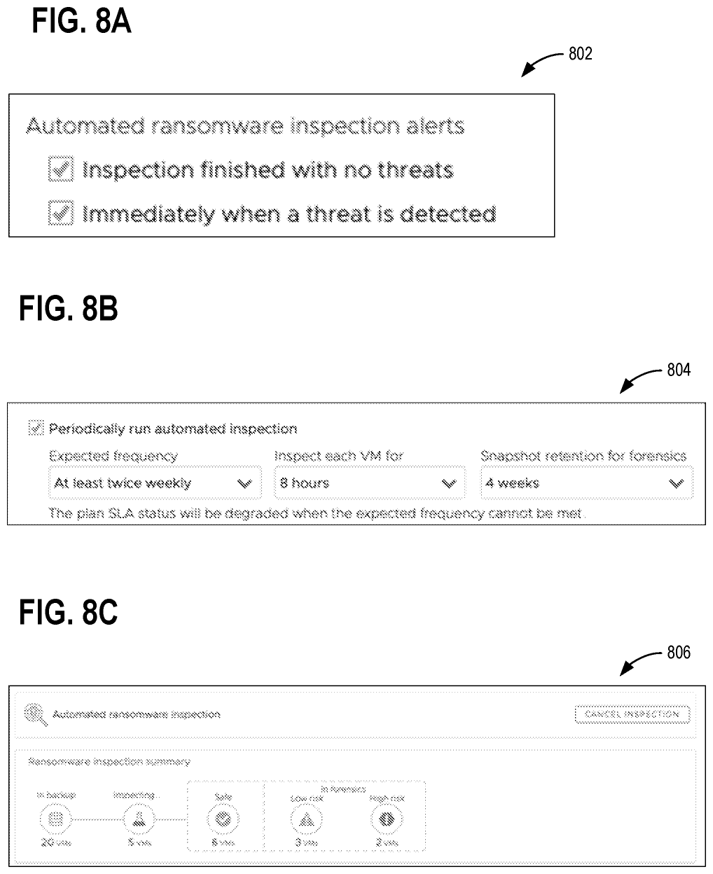

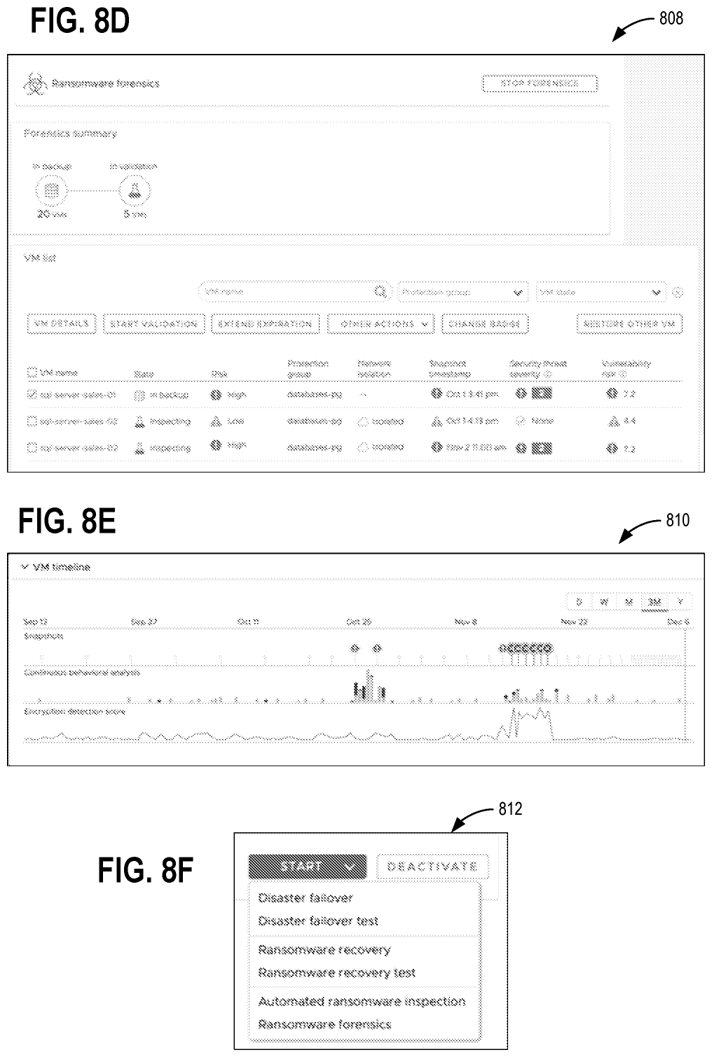

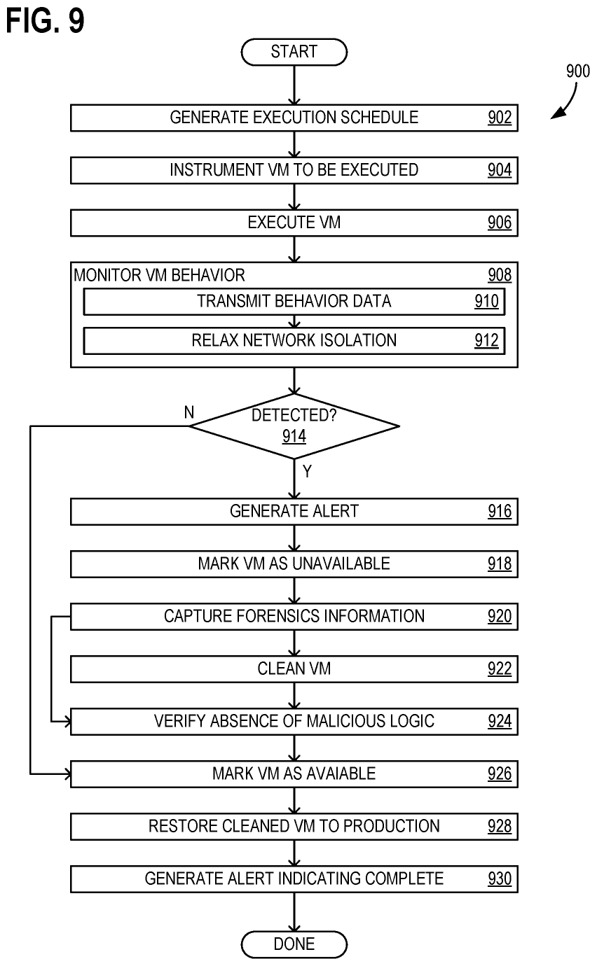

Production environment 300 is illustrated in further detail in FIG. 3; isolation environment 400 is illustrated in further detail in FIG. 4; EDR node 500 is illustrated in further detail in FIG. 5; and orchestrator 600 is illustrated in further detail in FIG. 6. Messaging among the various components of architecture is shown in FIG. 7. Examples of UI displays for UI 800 are shown in FIGS. 8A-8F.

While some examples are described in the context of VMs, aspects of the disclosure are operable with any form of virtual computing infrastructure (VCI). As used herein, a VCI is any isolated software entity that can run on a computer system, such as a software application, a software process, container, or a VM. Examples of architecture 100 are operable with virtualized and non-virtualized storage solutions. For example, any of objects 201-204, described below, may correspond to any of VMs 312, 314, and 322-328.

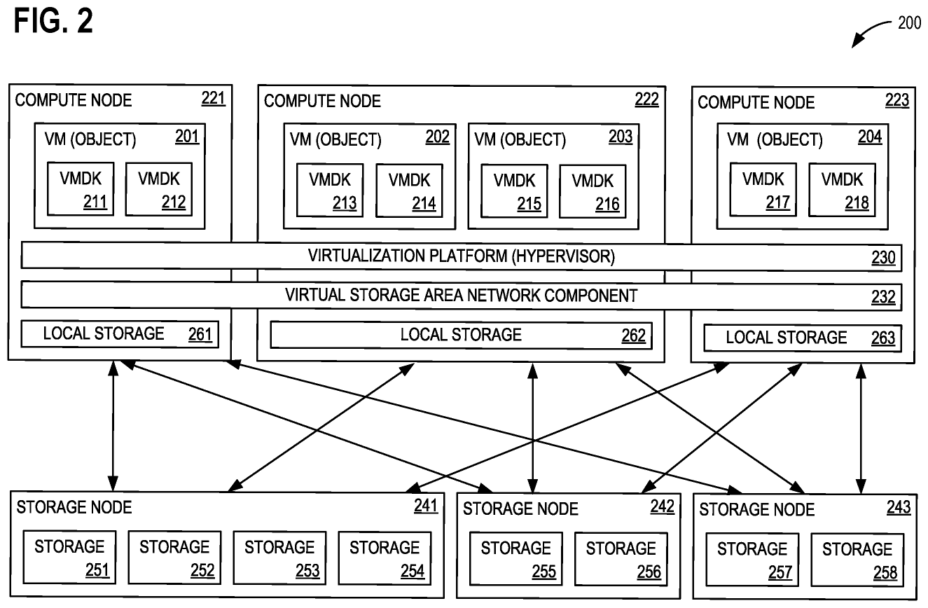

FIG. 2 illustrates a virtualization architecture 200 that may be used as a component of architecture 100. Virtualization architecture 200 is comprised of a set of compute nodes 221-223, interconnected with each other and a set of storage nodes 241-243 according to an embodiment. In other examples, a different number of compute nodes and storage nodes may be used. Each compute node hosts multiple objects, which may be virtual machines, containers, applications, or any compute entity (e.g., computing instance or virtualized computing instance) that consumes storage. A virtual machine includes, but is not limited to, a base object, linked clone, independent clone, and the like. A compute entity includes, but is not limited to, a computing instance, a virtualized computing instance, and the like.

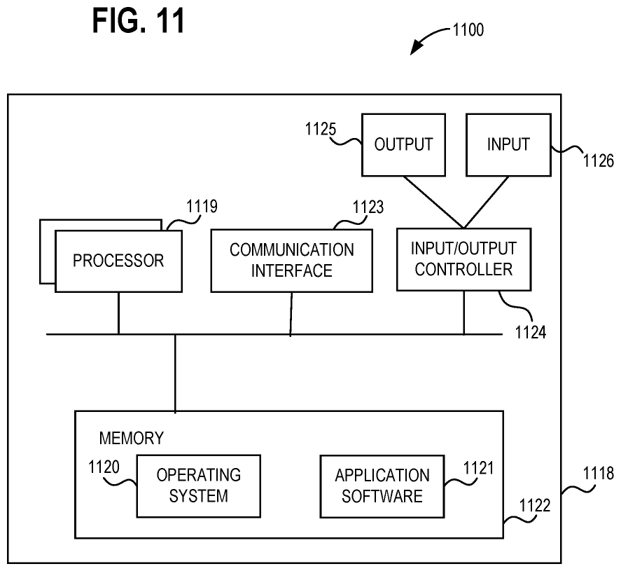

When objects are created, they may be designated as global or local, and the designation is stored in an attribute. For example, compute node 221 hosts object 201, compute node 222 hosts objects 202 and 203, and compute node 223 hosts object 204. Some of objects 201-204 may be local objects. In some examples, a single compute node may host 50, 100, or a different number of objects. Each object uses a VMDK, for example VMDKs 211-218 for each of objects 201-204, respectively. Other implementations using different formats are also possible. A virtualization platform 230, which includes hypervisor functionality at one or more of compute nodes 221, 222, and 223, manages objects 201-204. In some examples, various components of virtualization architecture 200, for example compute nodes 221, 222, and 223, and storage nodes 241, 242, and 243 are implemented using one or more computing apparatus such as computing apparatus 1118 of FIG. 11.

Virtualization software that provides software-defined storage (SDS), by pooling storage nodes across a cluster, creates a distributed, shared datastore, for example a SAN. Thus, objects 201-204 may be virtual SAN (vSAN) objects. In some distributed arrangements, servers are distinguished as compute nodes (e.g., compute nodes 221, 222, and 223) and storage nodes (e.g., storage nodes 241, 242, and 243). Although a storage node may attach a large number of storage devices (e.g., flash, solid state drives (SSDs), non-volatile memory express (NVMe), Persistent Memory (PMEM), quad-level cell (QLC)) processing power may be limited beyond the ability to handle input/output (I/O) traffic. Storage nodes 241-243 each include multiple physical storage components, which may include flash, SSD, NVMe, PMEM, and QLC storage solutions. For example, storage node 241 has storage 251, 252, 253, and 254; storage node 242 has storage 255 and 256; and storage node 243 has storage 257 and 258. In some examples, a single storage node may include a different number of physical storage components.

In the described examples, storage nodes 241-243 are treated as a SAN with a single global object, enabling any of objects 201-204 to write to and read from any of storage 251-258 using a virtual SAN component 232. Virtual SAN component 232 executes in compute nodes 221-223. Using the disclosure, compute nodes 221-223 are able to operate with a wide range of storage options. In some examples, compute nodes 221-223 each include a manifestation of virtualization platform 230 and virtual SAN component 232. Virtualization platform 230 manages the generating, operations, and clean-up of objects 201-204. Virtual SAN component 232 permits objects 201-204 to write incoming data from object 201-204 to storage nodes 241, 242, and/or 243, in part, by virtualizing the physical storage components of the storage nodes.

FIG. 3 illustrates further detail for production environment 300. Set 310 of active VMs is illustrated as having two VMs, VM 312 and VM 314, although it should be understood that some examples may have a different count. In some examples, production environment 300 may have hundreds of hosts or more, with thousands of VMs or more. A backup manager 304 creates backups of VM 312 and VM 314 on a backup schedule 306, or on demand (e.g., a backup request 722, described in relation to FIG. 7). In some examples, backup manager 304 represents functionality of virtualization platform 230, which also includes functionality represented by hypervisor 302.

Production environment 300 includes its own behavior monitor 350 for monitoring behavior of VM 312 and VM 314 to detect the presence of manifesting malicious logic, and collects behavior data 352. In some examples, behavior monitor 350 uses machine learning (ML) or artificial intelligence (AI), and employs NGAV techniques. In some examples, behavior data 352 is sent to EDR node 500 and/or deep forensics node 160 (as shown in FIG. 7). Detection of malicious logic in production environment 300 uses a probability of detection (Pd) 354, which is balanced with a probability of false alarm (Pfa) to meet the operational needs of production environment 300.

In general, setting detection sensitive enough to increase Pd of some event also increases Pfa for that event. Higher Pd may also consume more computing resources for the higher sensitivity. Thus, a high Pd is generally more computationally burdensome on the environment. Since production environment 300 likely has performance goals, Pd 354 and Pfa are set according to a sensitivity level that balances the need for rapid detection without overly burdening production environment 300.

A response logic 356 reacts to an alert 714 (of FIG. 7) that malicious logic has been detected within a VM that is within production environment 300 (e.g., backup VM 322). Each VM of a plurality of backup VMs 320 has a flag that is set to indicate whether malicious logic has been detected, the VM has been examined and found to be clear of malicious logic, or the VM has not yet been checked for malicious logic. Some examples may use separate flags for the different conditions. Some examples may use an environmental setting, such as an operating system (OS) command to lock a VM found to have malicious logic. Some examples do not set flags for the VMs, but instead move the VMs among different folders that indicate the condition.

As illustrated, backup VM 322 has an associated flag 332, backup VM 324 has an associated flag 334, backup VM 326 has an associated flag 336, and backup VM 328 has an associated flag 338. Backup VMs 322, 324, and 326 are within a folder 342 of available backup VMs within storage 340. Folder 342 holds backup VMs that are designated as available to use for DR backups. In the illustrated scenario, response logic 356 has not received alert 714 that alerts production environment 300 that backup VM 322 contains malicious logic 422.

When response logic 356 does receive alert 714, response logic 356 sets flag 332 to indicate that backup VM 322 is unavailable for use (i.e., should not be used) for DR backup purposes, and/or moves backup VM 322 to another folder 344 on storage 340 that is for VMs that have been determined to be unavailable for backup restore use (e.g., use for DR backup purposes). So long as backup VM 322 is properly locked (by the OS), flag 332 is set properly, or backup VM 322 remains archived within folder 344, backup VM 322 may be retained for a prolonged period for forensics, with minimal resource use and minimal risk to production environment 300. Backup VM 322 may be restarted for forensics purposes, resuming its execution with the memory state matching the state at the time of archiving.

In some examples, failed VMs are kept in the IRE for a configurable retentional interview, where they continue to execute and can be examined by security administrators. Upon completion of the retention interval, the failed VMs are archived. An archiving operation preserves the entire VM state including its memory. An example archiving operation includes suspending the VM, writing out VM memory state to storage and powering off the VM, snapshotting the on-disk VM state with the snap expiry set to an archiving interval, and unregistering the VM from the virtualization platform. An archived VM does not consume any CPU or memory resources, and can be kept on disk for a long interval. An archived VM can be unarchived for forensics research by restoring it from a storage snapshot, registering with a virtualization platform, and powering it on. The VM will resume its execution with the memory state matching its state at the archiving time preserving the memory modifications made by fileless or LOTL attacks.

If however, it turns out that detection of malicious logic within backup VM 322 was a false alarm (i.e., malicious logic 422 does not actually exist within backup VM 322), or after malicious logic 422 (which did exist) has been removed from backup VM 322, a certification 706 (of FIG. 7) is sent to response logic 356. Based on receiving certification 706, response logic 356 sets flag 332 sets flag 332 to indicate that backup VM 322 is available for backup restore use, and/or moves backup VM 322 to folder 342. In some examples, there are 3 folders, one for VMs that have been certified free of malicious logic, one for VMs with detected malicious logic, and one for VMs that have not yet been checked.

FIG. 4 illustrates further detail for isolation environment 400. In some examples, isolation environment 400 may be much smaller than production environment 300, and have two or three hosts until disaster recovery is needed. During recovery, resources may be moved from production environment 300 into an IRE, of which isolation environment 400 is a part. Upon completion of the recovery, resources are returned to production environment 300. In typical operation, isolation environment 400 may be 10% or less of the size of production environment 300 in terms of resources (e.g., the count of hosts).

Execution controller 402 executes each backup VM of plurality of backup VMs 320 in execution environment 420, according to execution schedule 404. In some examples, execution environment 420 is a sandbox within isolation environment 400, to contain the effects of any manifesting malicious logic. Execution schedule 404 may be set to provide full use of resources available to isolation environment 400. The purpose is to prompt any latent malicious logic to manifest itself within isolation environment 400 prior to manifestation of malicious logic in an active VM within production environment 300.

That is, the execution of backup VM 322 within isolation environment 400 is performed prior to detecting a cyberattack within production environment 300. This means that the detection activity is proactive, and does not wait for manifestation of a cyberattack within production environment 300. The phrase “prior to a cyberattack within production environment 300” does not require that any cyberattack actually occur within production environment 300, but includes scenarios in which a cyberattack never occurs within production environment because it is thwarted or deterred.

In some examples, certain aspects of execution of backup VM 322 within isolation environment 400 may differ from execution of an active VM (e.g., VM 312) within production environment 300. For example, clock cycles and the system date (as reported by the OS) may be sped up to simulate execution on advanced dates, in order to trigger delayed ransomware activity. Another example is that a network isolation level 406 for backup VM 322 is relaxed from the most restrictive (upon startup) to completely open, to provoke malicious behavior. That is, network isolation level 406 may start out as highly restrictive and loosen up as execution of backup VM 322 proceeds.

In some examples, an instrumenter 426 instruments backup VM 322 and each of the other backup VM that is to be executed, to improve the likelihood that behavior monitor 450 will detect activity of malicious logic 422 by collecting an enhanced set of information in behavior data 452. That is, in some examples, instrumentation 424, inserted into backup VM 322 by instrumenter 426, results in behavior data 452 being more comprehensive than behavior data 352, collected in production environment 300.

The result of this is that a Pd 454, within isolation environment 400, may be higher than Pd 354 of production environment 300. This is acceptable, in some scenarios, even with a potentially higher Pfa and higher detection burden, because isolation environment 400 does not have the same performance constraints as production environment 300, due to customers (e.g., users) of production environment 300 not relying on isolation environment 400 for workload operations.

Behavior data 452 is sent to EDR node 500 and/or deep forensics node 160, as described below in relation to FIG. 7. A response logic 456 receives an alert 716 that malicious logic has been detected within backup VM 322 and or a certification 708 that backup VM 322 is free of (or has been cleaned from) malicious logic. Response logic functionality within an example architecture is spread among at least a response logic 356 within production environment 300, response logic 456 within isolation environment 400, a response logic 556 within EDR node 500, and a response logic 656 within orchestrator 600.

Response logic 456 may set flags within any of backup VMs 322-328 (e.g., any of flags 332-338) to indicate that a VM is available or unavailable for use, and/or trigger a snapshot manager 430 to generate a memory snapshot 432 for backup VM 322. As shown in FIG. 7, and described below, memory snapshot 432 is sent to EDR node 500 and/or deep forensics node 160.

FIG. 5 illustrates further detail for EDR node 500. EDR node 502 has an EDR logic 502 that operates on forensics information 504, and includes response logic 556 that generates alerts in response to detection of, or failing to detect, malicious logic from forensics information. In some examples, EDR logic 502 uses ML. As illustrated, forensics information 504 includes behavior data 352 (collected when the VM that was backed up into backup VM 322 was operating in production environment 300), behavior data 452, and memory snapshot 432. Some examples may have more or less information in forensics information 504.

In some examples, a cleaner 510 removes malicious logic 422 from backup VM 322. In some examples, cleaner 510 may be located elsewhere, in addition to or instead of EDR node 500, such as in isolation environment 400, deep forensics node 160, and/or production environment 300.

FIG. 6 illustrates further detail for orchestrator 600. Orchestrator 600 has a configuration manager 602 that accepts input from a user via UI 800 and stores parameters and option selections in settings 604. Settings 604 may be used to create or modify a verification plan 610. In some examples, verification plan 610 starts out as a DR plan for performing DR using backup VMs in an IRE, and is modified, and/or contains components of a prior-existing DR plan. Scheduler 620 uses verification plan 610 and/or settings 604 to generate execution schedule 404 that is used for executing plurality of backup VMs 320 in isolation environment 400. In some examples, configuration manager 602 permits a user to reallocate resources among production environment 300 and isolation environment 400 to balance customer performance in production environment 300 and capability of isolation environment 400.

Together, verification plan 610, settings 604, and execution schedule 404 break plurality of backup VMs 320 into batches in some examples, based on the available resources in isolation environment 400, and execute each backup VM of plurality of backup VMs 320 for some minimum amount of time, with selected instrumentation (e.g., instrumentation 424) and selected network isolation levels (e.g., network isolation level 406).

Response logic 656, which is a component of the overall response functionality of architecture that includes response logic 356, 456, 556, and 656, responds to various incoming requests, alerts, and certifications, interprets them, and transmits out its own set of alerts requests, alerts, and certifications. These are illustrated in FIG. 7.

As shown in FIG. 7, production environment 300 sends plurality of backup VMs 320 (which includes backup VM 322) to isolation environment 400. Production environment 300 also sends behavior data 352 to EDR node 500 and/or deep forensics node 160 for determination of whether malicious logic is present in an active VM. In some examples, behavior data 352 is transmitted independently of whether malicious logic is detected at production environment 300, whereas in some examples, behavior data 352 is transmitted only when production environment 300 detects a sufficient probability of the presence of malicious logic.

In some examples, production environment 300 and isolation environment 400 use the same EDR node 500. In other examples, production environment 300 and isolation environment 400 do not use the same EDR instance. In such examples, production environment 300 and isolation environment 400 use EDRs from different vendors for better coverage.

Isolation environment 400 transmits behavior data 452 to EDR node 500 and/or deep forensics node 160 for determination of whether malicious logic is present in backup VM 322. Isolation environment 400 also sends memory snapshot 432 and/or backup VM 322 to EDR node 500 and/or deep forensics node 160 for further analysis. When deep forensics node 160 finishes cleaning malicious logic 422 from VM 322 or otherwise determines that backup VM 322 is free from malicious logic 422, deep forensics node 160 transmits a certification 702 to orchestrator 600.

Similarly, when EDR node 500 finishes cleaning malicious logic 422 from backup VM 322 or otherwise determines that backup VM 322 is free from malicious logic 422, EDR node 500 transmits a certification 704 to orchestrator 600. Orchestrator 600 then transmits a corresponding certification 706 to production environment 300 and a certification 708 to isolation environment 400, so that backup VM 322 may be moved to the correct folder for available backups or flag 332 may be set to indicate no malicious logic. In some examples, when all of plurality of backup VMs 320 have been found to be free of malicious logic (e.g., by cleaning or otherwise), EDR node 500 transmits an alert 710 to orchestrator 600, informing orchestrator 600 that the validation of all of plurality of backup VMs 320 is complete.

When malicious logic 422 is found within backup VM 322, EDR node 500 transmits an alert 710 to orchestrator 600. Response logic 656 in orchestrator 600 receives alert 712 and transmits a corresponding alert 714 to production environment 300 and an alert 716 to isolation environment 400, so that backup VM 322 may be moved to the correct folder for unavailable backups or flag 332 may be set to indicate the presence of malicious logic. In some scenarios, EDR node 500 transmits a backup request 720 to orchestrator 600, either based on a backup schedule, or detecting suspicious activity in behavior data 352 indicating that a cyberattack may have begun in production environment 300. Orchestrator 600 then forwards this request to production environment 300 as backup request 722. In some examples, backup request 722 also triggers a new verification of the currently-executing active VM producing behavior data 352.

FIG. 8A illustrates an exemplary UI display 802 presented by UI 800 that prompts a user to select whether alert 712 triggers a user notification (“Inspection finished with no threats”) and/or alert 710 also triggers a user notification (“Immediately when a threat is detected”). FIG. 8B illustrates an exemplary UI display 804 presented by UI 800 that prompts a user to select scheduling options for execution schedule 404 and a retention option.

FIG. 8C illustrates an exemplary UI display 806 used for reporting validation results and status for a set of VMs. FIG. 8D illustrates an exemplary UI display 808 showing more detailed forensics results from EDR node 500 than the summary of UI display 806. FIG. 8E illustrates an exemplary UI display 810 showing a timeline of malicious logic detections, that may be displayed by UI 800. FIG. 8F illustrates an exemplary UI display 812 for generic control of the various functionality of architecture 100.

In some examples, architecture 100 includes disaster recovery as a service (DRaaS) and/or scale-out cloud filesystem (SCFS) components (e.g., isolation environment 400). In some examples, architecture 100 also includes ransomware recovery (RWR) implemented using software as a service (SaaS) in EDR node 500 and/or an IRE. In some examples, portions of architecture 100 use software defined data centers (SDDCs) that are hosted within cloud computing provider facilities.

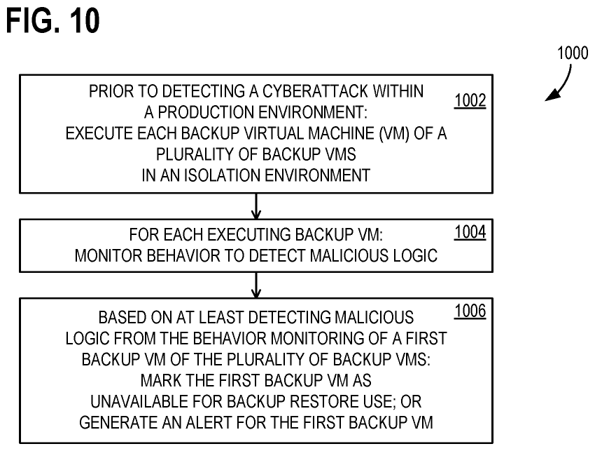

FIG. 9 illustrates a flowchart 900 of exemplary operations that may be performed by examples of architecture 100. In some examples, the operations of flowchart 900 are performed by one or more computing apparatus 1118 of FIG. 11. Flowchart 900 commences with generating execution schedule 404 for plurality of backup VMs 320 in operation 902, to make continual use of resources of isolation environment 400. In some examples, each backup VM comprises a VMDK snapshot. In some examples, all VMs in plurality of backup VMs 320 are processed concurrently, brought into isolation environment 400, and verified together. Flowchart 900 is described for backup VM 322; the other backup VMs 324-328 are handled similarly.

Operation 904 instruments backup VM 322 for the behavior monitoring, and in subsequent passes through flowchart 900, operation 904 also instruments each of the other backup VMs of plurality of backup VMs 320. Operation 906 executes backup VM 322 in isolation environment 400 prior to detecting a cyberattack within production environment 300. In subsequent passes, operation 906 also executes each of the other backup VMs of plurality of backup VMs 320 in isolation environment 400. In some examples, executing each of backup VMs 322-328 comprises executing each backup VM according to execution schedule.

Operation 908 monitors behavior to detect malicious logic for each executing backup VM, and includes operations 910 and 912. In some examples, operation 908 monitors behavior with higher Pd 454 for detection of malicious logic in isolation environment 400 than Pd 354 for detection of malicious logic used in production environment 300. In some examples, monitoring behavior to detect malicious logic comprises performing behavioral analysis of VM execution using ML. Operation 910 transmits behavior data 452 from isolation environment 400 to EDR node 500, and operation 912 incrementally increases network isolation level 406.

Decision operation 914 determines whether malicious logic has been detected. If not, flowchart 900 moves to operation 924, described below. However, if malicious logic has been detected, flowchart 900 moves to operation 916, which generates alert 712. In operation 918, backup VM 322 is marked as unavailable for backup restore use, for example by setting flag 332 to indicate a presence of malicious logic and/or moving backup VM 322 out from folder 342 of available backup VMs into an archive, folder 344 of unavailable backup VMs.

Forensics information 504 and/or 162 is captured in operation 920, including generating memory snapshot 432 for backup VM 322. Operation 922 removes malicious logic 422 from backup VM 322, for example in deep forensics node 160 and/or in EDR node 500. After cleaning, flowchart 900 moves to operation 924.

In some scenarios, the detection of malicious logic in decision operation 914 is a false alarm, and further examination (e.g., in deep forensics node 160) reveals that there really is no malicious logic. Operation 924 verifies the absence of malicious logic in backup VM 322. In such scenarios, flowchart 900 reaches operation 924 directly from operation 920. Operation 926 marks backup VM 322 as available for backup restore use, based on at least a forensics investigation verifying an absence of malicious logic in backup VM 322. This verification may arise from operation 924 or a negative result in decision operation 914. In some examples, marking backup VM 322 as available for backup restore use comprises setting flag 332 to indicate an absence of malicious logic, and/or moving backup VM 322 into folder 342 of available backup VMs.

Backup VM 322 is restored to production in production environment 300, in operation 928. determines whether there is another backup VM of plurality of backup VMs 320 to execute according to execution schedule 404. If so, flowchart 900 returns to operation 904 to instrument the next backup VM. Otherwise, operation 930 generates alert 710, based on at least not detecting malicious logic from the behavior monitoring for any backup VM of plurality of backup VMs 320.

FIG. 10 illustrates a flowchart 1000 of exemplary operations that may be performed by examples of architecture 100. In some examples, the operations of flowchart 1000 are performed by one or more computing apparatus 1118 of FIG. 11. Flowchart 1000 commences with operation 1002, which includes, prior to detecting a cyberattack within a production environment, executing each backup virtual machine (VM) of a plurality of backup VMs in an isolation environment.

Operation 1004 includes, for each executing backup VM, monitoring behavior to detect malicious logic. Operation 1006 includes, based on at least detecting malicious logic from the behavior monitoring of a first backup VM of the plurality of backup VMs: marking the first backup VM as unavailable for backup restore use; and/or generating an alert for the first backup VM.

### Additional Examples

An example computerized method comprises: prior to detecting a cyberattack within a production environment, executing each backup VM of a plurality of backup VMs in an isolation environment; for each executing backup VM, monitoring behavior to detect malicious logic; and based on at least detecting malicious logic from the behavior monitoring of a first backup VM of the plurality of backup VMs: marking the first backup VM as unavailable for backup restore use; or generating an alert for the first backup VM.

An example system comprises: an execution controller for executing each backup VM of a plurality of backup VMs in an isolation environment, prior to detecting a cyberattack within a production environment; a behavior monitor for monitoring behavior of each executing backup VM to detect malicious logic; and response logic to, based on at least detecting malicious logic from the behavior monitoring of a first backup VM of the plurality of backup VMs: mark the first backup VM as unavailable for backup restore use; or generate an alert for the first backup VM.

One or more example non-transitory computer storage media have computer-executable instructions that, upon execution by a processor, cause the processor to at least: prior to detecting a cyberattack within a production environment, execute each backup VM of a plurality of backup VMs in an isolation environment; for each executing backup VM, monitor behavior to detect malicious logic with a higher Pd for detection of malicious logic in the isolation environment than a Pd for detection of malicious logic used in the production environment; and based on at least detecting malicious logic from the behavior monitoring of a first backup VM of the plurality of backup VMs: mark the first backup VM as unavailable for backup restore use; and generate an alert for the first backup VM.

Alternatively, or in addition to the other examples described herein, examples include any combination of the following:
marking the first backup VM as unavailable for backup restore use comprises setting a flag associated with the first backup VM;
marking the first backup VM as unavailable for backup restore use comprises moving the first backup VM out from a folder of available backup VMs;
cleaning the detected malicious logic from the first backup VM;
generating a memory snapshot for the first backup VM;
executing each backup VM comprises incrementally relaxing a network isolation level for the executing backup VM;
monitoring behavior to detect malicious logic comprises: monitoring behavior with a higher Pd for detection of malicious logic in the isolation environment than a Pd for detection of malicious logic used in the production environment;
based on at least a forensics investigating verifying an absence of malicious logic in the first backup VM, marking the first backup VM as available for backup restore use;
marking the first backup VM as available for backup restore use comprises setting a flag associated with the first backup VM;
marking the first backup VM as available for backup restore use comprises moving the first backup VM into a folder of available backup VMs;
instrumenting each backup VM of the plurality of backup VMs for the behavior monitoring;
generating an execution schedule for the plurality of backup VMs;
executing each backup VM comprises executing each backup according to the execution schedule;
based on at least detecting malicious logic from the behavior monitoring of the first backup VM, cleaning the malicious logic from the first backup VM;
verifying an absence of malicious logic in the first backup VM;
the isolation environment comprises an IRE;
the production environment comprises ten times the count of hosts as the isolation environment;
each backup VM comprises a VMDK snapshot;
monitoring behavior to detect malicious logic comprises performing behavioral analysis of VM execution;
monitoring behavior of an executing backup VM comprises transmitting behavior data from the isolation environment to an EDR node;
generating the memory snapshot for the first backup VM is based on at least detecting malicious logic from the behavior monitoring of the first backup VM;
capturing forensics information, including a memory snapshot for the first backup VM, based on at least detecting malicious logic from the behavior monitoring of the first backup VM;
setting a flag associated with each backup VM to indicate a presence or absence of malicious logic;
based on at least not detecting malicious logic from the behavior monitoring for any backup VM of the plurality of backup VMs, generating a second alert;
generating the execution schedule to make continual use of isolation environment resources;
a snapshot manager for generating a memory snapshot for the first backup VM;
a scheduler for generating an execution schedule for the plurality of backup VMs;
an instrumenter for instrumenting each backup VM of the plurality of backup VMs for the behavior monitoring; and
a cleaner for cleaning the malicious logic from the first backup VM.

### Exemplary Operating Environment

The present disclosure is operable with a computing device (computing apparatus) according to an embodiment shown as a functional block diagram 1100 in FIG. 11. In an embodiment, components of a computing apparatus 1118 may be implemented as part of an electronic device according to one or more embodiments described in this specification. The computing apparatus 1118 comprises one or more processors 1119 which may be microprocessors, controllers, or any other suitable type of processors for processing computer executable instructions to control the operation of the electronic device. Alternatively, or in addition, the processor 1119 is any technology capable of executing logic or instructions, such as a hardcoded machine. Platform software comprising an operating system 1120 or any other suitable platform software may be provided on the computing apparatus 1118 to enable application software 1121 (program code) to be executed by one or more processors 1119. According to an embodiment, the operations described herein may be accomplished by software, hardware, and/or firmware.

Computer executable instructions may be provided using any computer-readable medium (e.g., any non-transitory computer storage medium) or media that are accessible by the computing apparatus 1118. Non-transitory computer-readable media (computer storage media) may include, for example, computer storage media such as a memory 1122 and communications media. Computer storage media, such as a memory 1122, include volatile and non-volatile, removable, and non-removable media implemented in any method or technology for storage of information such as computer readable instructions, data structures, program modules or the like. Computer storage media include, but are not limited to, hard disks, RAM, ROM, EPROM, EEPROM, NVMe devices, persistent memory, phase change memory, flash memory or other memory technology, compact disc (CD, CD-ROM), digital versatile disks (DVD) or other optical storage, magnetic cassettes, magnetic tape, magnetic disk storage, shingled disk storage or other magnetic storage devices, or any other non-transmission medium (e., non-transitory) that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium does not include a propagating signal per se. Propagated signals per se are not examples of computer storage media. Although the computer storage medium (the memory 1122) is shown within the computing apparatus 1118, it will be appreciated by a person skilled in the art, that the storage may be distributed or located remotely and accessed via a network or other communication link (e.g. using a communication interface 1123). Computer storage media are tangible, non-transitory, and are mutually exclusive to communication media.

The computing apparatus 1118 may comprise an input/output controller 1124 configured to output information to one or more output devices 1125, for example a display or a speaker, which may be separate from or integral to the electronic device. The input/output controller 1124 may also be configured to receive and process an input from one or more input devices 1126, for example, a keyboard, a microphone, or a touchpad. In one embodiment, the output device 1125 may also act as the input device. An example of such a device may be a touch sensitive display. The input/output controller 1124 may also output data to devices other than the output device, e.g. a locally connected printing device. In some embodiments, a user may provide input to the input device(s) 1126 and/or receive output from the output device(s) 1125.

The functionality described herein can be performed, at least in part, by one or more hardware logic components. According to an embodiment, the computing apparatus 1118 is configured by the program code when executed by the processor 1119 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although described in connection with an exemplary computing system environment, examples of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices.

Examples of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special purpose computing device when programmed to execute the instructions described herein. The detailed description provided above in connection with the appended drawings is intended as a description of a number of embodiments and is not intended to represent the only forms in which the embodiments may be constructed, implemented, or utilized. Although these embodiments may be described and illustrated herein as being implemented in devices such as a server, computing devices, or the like, this is only an exemplary implementation and not a limitation. As those skilled in the art will appreciate, the present embodiments are suitable for application in a variety of different types of computing devices, for example, PCs, servers, laptop computers, tablet computers, etc.

The term “computing device” and the like are used herein to refer to any device with processing capability such that it can execute instructions. Those skilled in the art will realize that such processing capabilities are incorporated into many different devices and therefore the terms “computer”, “server”, and “computing device” each may include PCs, servers, laptop computers, mobile telephones (including smart phones), tablet computers, and many other devices. Any range or device value given herein may be extended or altered without losing the effect sought, as will be apparent to the skilled person. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While no personally identifiable information is tracked by aspects of the disclosure, examples may have been described with reference to data monitored and/or collected from the users. In some examples, notice may be provided, such as via a dialog box or preference setting, to the users of the collection of the data (e.g., the operational metadata) and users are given the opportunity to give or deny consent for the monitoring and/or collection. The consent may take the form of opt-in consent or opt-out consent.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” and “the” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computerized method comprising:
prior to detecting a cyberattack within a production environment, executing each backup virtual machine (VM) of a plurality of backup VMs in an isolation environment;
for each executing backup VM, monitoring behavior to detect malicious logic; and
based on at least detecting malicious logic from the behavior monitoring of a first backup VM of the plurality of backup VMs:
marking the first backup VM as unavailable for backup restore use; or
generating an alert on a user interface for the first backup VM.

2. The computerized method of claim 1, wherein marking the first backup VM as unavailable for backup restore use comprises:
setting a flag associated with the first backup VM; or
moving the first backup VM out from a folder of available backup VMs.

3. The computerized method of claim 1, further comprising:
cleaning the detected malicious logic from the first backup VM.

4. The computerized method of claim 1, further comprising:
generating a memory snapshot for the first backup VM.

5. The computerized method of claim 1, wherein executing each backup VM comprises:
incrementally relaxing a network isolation level for the executing backup VM.

6. The computerized method of claim 1, wherein monitoring behavior to detect malicious logic comprises:
monitoring behavior with a higher probability of detection (Pd) for detection of malicious logic in the isolation environment than a Pd for detection of malicious logic used in the production environment.

7. The computerized method of claim 1, further comprising:
based on at least a forensics investigating verifying an absence of malicious logic in the first backup VM, marking the first backup VM as available for backup restore use, wherein marking the first backup VM as available for backup restore use comprises:
setting a flag associated with the first backup VM; or
moving the first backup VM into a folder of available backup VMs.

8. The computerized method of claim 1, further comprising:
instrumenting each backup VM of the plurality of backup VMs for the behavior monitoring.

9. The computerized method of claim 1, further comprising:
generating an execution schedule for the plurality of backup VMs, wherein executing each backup VM comprises executing each backup VM according to the execution schedule.

10. The computerized method of claim 1, further comprising:
based on at least detecting malicious logic from the behavior monitoring of the first backup VM, cleaning the malicious logic from the first backup VM; and
verifying an absence of malicious logic in the first backup VM.

11. A system comprising:
an execution controller for executing each backup virtual machine (VM) of a plurality of backup VMs in an isolation environment, prior to detecting a cyberattack within a production environment;
a behavior monitor for monitoring behavior of each executing backup VM to detect malicious logic; and
response logic to, based on at least detecting malicious logic from the behavior monitoring of a first backup VM of the plurality of backup VMs:
mark the first backup VM as unavailable for backup restore use; or
generate an alert for the first backup VM.

12. The system of claim 11, wherein marking the first backup VM as unavailable for backup restore use comprises:
setting a flag associated with the first backup VM; or
moving the first backup VM out from a folder of available backup VMs.

13. The system of claim 11, further comprising:
a snapshot manager for generating a memory snapshot for the first backup VM.

14. The system of claim 11, further comprising:
a scheduler for generating an execution schedule for the plurality of backup VMs.

15. The system of claim 11, further comprising:
an instrumenter for instrumenting each backup VM of the plurality of backup VMs for the behavior monitoring.

16. The system of claim 11, further comprising:
a cleaner for cleaning the malicious logic from the first backup VM.

17. One or more computer storage media having computer-executable instructions that, upon execution by a processor, cause the processor to at least:
prior to detecting a cyberattack within a production environment, execute each backup virtual machine (VM) of a plurality of backup VMs in an isolation environment;
for each executing backup VM, monitor behavior to detect malicious logic with a higher probability of detection (Pd) for detection of malicious logic in the isolation environment than a Pd for detection of malicious logic used in the production environment; and
based on at least detecting malicious logic from the behavior monitoring of a first backup VM of the plurality of backup VMs:
mark the first backup VM as unavailable for backup restore use; and
generate an alert for the first backup VM.

18. The computer storage media of claim 17, wherein marking the first backup VM as unavailable for backup restore use comprises:
set a flag associated with the first backup VM; or
move the first backup VM out from a folder of available backup VMs.

19. The computer storage media of claim 17, wherein the computer-executable instructions, upon execution by a processor, further cause the processor to at least:
transmit behavior data from the isolation environment to an endpoint detection and response (EDR) node.

20. The computer storage media of claim 17, wherein the computer-executable instructions, upon execution by a processor, further cause the processor to at least:
based on at least a forensics investigating verifying an absence of malicious logic in the first backup VM, mark the first backup VM as available for backup restore use, wherein marking the first backup VM as available for backup restore use comprises:
setting a flag associated with the first backup VM; or
moving the first backup VM into a folder of available backup VMs.
